(19) United States
(12) Patent Application Publication
(10) Pub. No.: US 2018/0058901 A1
(43) Pub. Date: Mar. 1, 2018

(54) Apparatus for Level Measurement of a Medium in a Container, and Arrangement of Such an Apparatus on a Container

(71) Applicant: BERTHOLD TECHNOLOGIES GmbH & Co. KG, Bad Wildbad (DE)

(72) Inventors: Dirk MOERMANN, Bischweier (DE); Stephan HIRSCH, Mannheim (DE)

(21) Appl. No.: 15/689,238

(22) Filed: Aug. 29, 2017

(30) Foreign Application Priority Data
Aug. 30, 2016 (EP) 16186245.3

(51) Int. Cl. G01F 23/288; G01N 23/06; B01D 17/02

(52) U.S. Cl. CPC G01F 23/2885; B01D 17/0211; G01N 23/06

(57) ABSTRACT

An apparatus for measuring the level of a medium in a container has a plurality of radioactive emitters which are mutually movable in order to be arranged at a different height level in each case in the container, a protective tube reaching into the container with an extent at least partially in the vertical direction, and an elongate holding device for the emitters, which is introducible into the protective tube and to which the emitters are fastened. A storage device for the holding device together with the emitters, a connection from the storage device to the protective tube, and a conveying device for conveying the holding device into the protective tube and out of the latter are also provided, wherein the holding device is configured to be length-invariant.

### CROSS REFERENCE TO RELATED APPLICATIONS

This application claims priority of European Patent Application No. 16186245.3, filed Aug. 30, 2016, the entire disclosure of which is herein expressly incorporated by reference.

### BACKGROUND AND SUMMARY OF THE INVENTION

The invention relates to an apparatus for measuring the level and/or for or measuring the density profile of a medium in a container, and to an arrangement of such an apparatus on a container.

U.S. Pat. No. 6,633,625 B2 discloses a similar apparatus and a corresponding arrangement. Emitters are arranged here in a protective tube which reaches into a container having a liquid medium. A further protective tube with detectors therein is arranged in parallel and at a small distance, wherein the detectors are arranged at the same height as the emitters. The emitters can be arranged here on a holding rod.

A further similar apparatus is known from US 2016/313264 A1. A plurality of flexible metal tubes are provided here which reach into a container having a medium therein. One emitter is provided per metal tube, wherein the emitters are arranged at a different height.

A disadvantage of these arrangements is the complexity if the emitters have to be removed some day from such a protective tube or metal tube, for example for maintenance purposes or for internal cleaning of the container.

The invention is based on the problem of providing an apparatus mentioned at the beginning and an arrangement of such an apparatus on a container, with which problems of the prior art can be solved, and it is possible in particular to arrange a plurality of emitters in a container and also to permit practicable removal of the emitters from the protective tube and to keep the distance of emitter to emitter constant.

This problem is solved by an apparatus for measuring a level and/or for measuring a density profile of a medium in a container, wherein said apparatus has:

a plurality of radioactive emitters being mutually movable in order to be arranged at a different height level in each case in said container;

a protective tube reaching into said container with an extent at least partially in a vertical direction;

an elongate holding device for said emitters, said elongate holding device being introducible into said protective tube, wherein said holding device is configured to be length-invariant, and wherein said emitters are fastened to said holding device,

a storage device for said holding device together with emitters,

a connection from said storage device to said protective tube,

a conveying device for said holding device for conveying said holding device into said protective tube and out of said protective tube, wherein said storage device for storing said holding device with said emitters thereon is configured in a non-elongate form.

The problem is also solved by an arrangement of the above apparatus on a container, preferably on a container for products of oil production separators, wherein said arrangement has a detector apparatus for detecting a position and/or a height of said emitters.

Advantageous and preferred refinements of the invention are a subject matter of the further claims and are explained in more detail below. Some of the features are described here only for the apparatus or only for the arrangement. Irrespective thereof, they are intended, however, to be able to apply independently of one another both for the apparatus and for the arrangement. The wording of the claims is incorporated in the contents of the description by express reference.

It is provided that the apparatus for measuring the level of a medium in a container has a plurality of radioactive emitters which are mutually movable in order to be arranged at a different height level in each case in the container. The distances of individual adjacent emitters can vary here or else can be at least partially or overall identical. Once the distance thereof with respect to one another has been fixed, it remains thus. The radioactive emitters used are customary radioactive emitters for such a purpose, as are described, for example, in U.S. Pat. No. 6,633,625 B2 or US 2016/313264 A1 which are mentioned above. They can be assigned corresponding detectors.

Furthermore, the apparatus has a protective tube which reaches into the container and which extends at least partially in the vertical direction. The protective tube can predominantly run in the vertical direction and here can either have bends between individual vertical portions or advantageously can run overall precisely vertically. It can also run parallel to a wall of the container and can be curved once or more than once here. An advantageous protective tube is configured rectilinearly.

The apparatus has an elongate holding device for the emitters, which is introducible into the protective tube, wherein the emitters are fastened to the holding device. The emitters are advantageously fastened releasably, for example by means of screw connections and the like, which cannot be released by themselves. The holding device can advantageously be at least partially flexible; more precise details in this regard are explained below. The apparatus also has a storage device for the holding device together with the emitters arranged thereon. A connection or a connecting channel is provided from the storage device to the protective tube, wherein the connecting channel is advantageously relatively short or is as short as possible. Furthermore, the apparatus has a conveying device for the holding device in order to convey or introduce the holding device into the protective tube and to convey or pull same out of the protective tube. This is necessary for cleaning, repairing, replacing or possibly also calibrating the emitters. The holding device here is configured to be length-invariant, i.e. non-varying in its length. This applies to forces of an order of magnitude which can occur in such an apparatus or in such an arrangement according to the invention. A holding device is advantageously length-invariant or is not length-variable up to forces of more than 100 N to 10 kN, particularly advantageously 500 N to 1 kN. A coefficient of temperature should also be taken into consideration such that, depending on the temperature, the elongate holding device does not lengthen too severely or change in its length. The use range of such apparatuses frequently lies at extreme temperatures, for example between −40° C. and 200° C. Over this temperature range, a change in length of the holding device should be within the range of below 1%, advantageously below 0.1%. It is thereby ensured that the emitters on the holding device, in the state introduced into the protective tube, are also always at the same and the desired location when this can be determined, for example, with reference to the position of an upper region of the holding device.

The storage device is configured according to the invention in such a manner that it stores the holding device with the emitters thereon in a non-elongate form or contains said holding device preferably in roundly or rounded-off consolidated or wound-up form.

When the holding device is at the same time at least partially flexible or bendable and length-invariant, it can be better stored in the rolled-up or rolled together, consolidated or other state in which it is reduced in storage volume in a storage device mentioned than, for example, a long rod. By means of the length invariance or unchangeable length, the accuracy of the apparatus for measuring the level can be retained because the distance of emitter to emitter is kept constant. This is important for the accuracy and reproducibility of the measurement result. The storage device or a storage space for the emitters therein is preferably encased with lead or another shielding material. This is cost-intensive and brings about a very high weight, and therefore a small overall size of the storage device is desirable. When the holding device together with emitters thereon is stored in rolled-up or consolidated form, it requires only a little space and height or volume and weight are saved. Both savings are desirable in general and in particular on oil platforms.

In a refinement of the invention, it is possible that the storage device has a rotatable drum, a winding hub or the like for winding up the holding device with the emitters thereof for storage, for example also a type of winding core. The holding device can be accommodated thereon in the storage device when the holding device is removed or taken out of the protective tube. Such a drum or a winding hub can either also form a conveying device for the holding device, as is explained in more detail below. The holding device can thus, as it were, be removed from the protective tube by winding up on the drum and can be introduced into the protective tube by unwinding from the drum. Alternatively and especially for precise positioning, a previously described conveying device which is separate from such a drum or the like can be provided which similarly also ensures the accuracy of the positioning of the holding device in the protective tube. It can also apply the primary force for pulling the holding device out of the protective tube. An aforementioned drum or the like then serves merely to accommodate the holding device with little space being required and especially also in ordered form and such that it can be readily discharged again.

In another refinement of the invention, it is possible for the storage device for storing the holding device with the emitters thereon to be configured in a roundedly consolidated form. The storage device here can be configured in such a manner that the holding device with the emitters thereon is deposited on a floor of the storage device in bays or similar form, i.e. loosely.

The shape of the storage device can be substantially approximately in the manner of a cube, and therefore the ratio of volume to walls is favourable.

In a further refinement of the invention, a storage device can be arranged directly at an outlet of the protective tube from the container. It can also be arranged directly above the protective tube, and therefore the connection mentioned at the beginning is very short or very direct. The storage device can advantageously be arranged here over the protective tube in such a manner that the holding device can run as directly as possible and without relatively great distances into the protective tube and therefore into the container. A connecting channel mentioned at the beginning is then short.

In an advantageous refinement of the invention, the protective tube runs precisely vertically. This is the simplest form of introducing and discharging the holding device together with emitters.

A corresponding apparatus is advantageously arranged at the top on a container in which the level height of a medium or more generally a density profile is intended to be measured. Boundary layers between a plurality of media, in particular sand, water, crude oil, gas or the like, in the case of oil extraction, can thus also be detected and the filling height or quantity thereof thus determined. This therefore applies to products of oil production separators. Levels or intermediate layers in the case of hydrocarbon/acids in alkylation units can likewise be established. The apparatus is particularly advantageously arranged here at a highest point of said container, wherein no other obstacles or apparatuses of a different type should be arranged in the container below the apparatus.

In a refinement of the invention, the holding device is at least partially composed of metal. As a result, both flexibility and an aforementioned length invariance can be achieved. In an advantageous refinement of the invention, the holding device is substantially composed of metal or even entirely of metal. Very good stability against aggressive media or a chemically aggressive atmosphere in the vicinity of the container is provided whenever said holding device is composed of stainless steel.

In a further refinement of the invention, the holding device is flexible in such a manner that it is movable in a flexurally flexible or articulated manner at least in one plane. This already permits the holding device to be rolled up or wound up on to a drum or the like in the storage device. Full flexibility or articulated moveability is not yet absolutely necessary, but can also be advantageous.

An advantageous holding device can have single-part and integral partial holders which are arranged or run between two adjacent emitters. For example, a plurality of such partial holders could be connected to one another in the region of the emitters to form the overall desired length of said holding device. A previously described flexibility or articulated moveability can be provided here in a connection to the emitters. The individual partial holders thus do not have to be flexible or articulated.

In an advantageous refinement of the invention, the holding device is stable or resistant with respect to a shearing force, which means it is advantageously shear-resistant. The effect which can thereby be achieved is that it can be introduced or pushed even into multiply bent protective tubes if, for example, the frictional force is greater than gravity, in order to allow the holding device together with emitters to slide into the protective tube. The holding device and emitters can thus be introduced or pushed even into, for example, multiply bent and/or long protective tubes. Stability with respect to a shearing force or shear-resistancy can be restricted here to forces within an anticipated range, preferably 10 N to 1 kN, in particular 50 N to 500 N.

In a possible refinement of the invention, the holding device is a shaft core or has such a shaft core. A shaft core with at least two layers of wound wires which run into each other is particularly advantageously used. The wires can be wound here in different directions to provide better stability of the shaft core. Said shaft core is particularly readily suitable for singly or else multiply bent protective tubes since it attempts to adjust itself as rectilinearly as possible or with a maximum bending radius.

In an alternative refinement of the invention, the holding device is a chain with individual chain segments. Even chains of this type are length-invariant and highly stable. A chain can be configured either in such a manner that it has chain links which are interconnected in an interlaced manner. A round link chain can be provided in particular here. Moveability in all direction is then also provided. Alternatively, a roller chain similar to a bicycle or drive chain can be used. Roller chains of this type can be moved or retracted and extended very easily with corresponding gearwheels. Positioning accuracy is also very high in this case. However, moveability is then provided only in one plane. Stability with respect to a shearing force is provided only to a limited extent in the case of a chain, and therefore chains can advantageously be used especially in vertical protective tubes. Said stability with respect to a shearing force also depends on the ratio of inside diameter of the protective tube to length of the chain link.

In an advantageous refinement of the invention, on the container, only a single protective tube for emitters is provided or emitters of the apparatus for detecting a level of a medium in the container are arranged only in a single protective tube. As a result, the construction can be kept simpler.

The apparatus advantageously has only a single holding devices for emitters. Thus, a plurality of holding device for emitters that could impede or damage one another during the introducing and discharging operation are not provided in particular in a single protective tube.

Emitters can be used in encapsulated or shielded form. Advantageously, one emitter or a single emitter is arranged here in one capsule. Such a capsule can then be installed in the longitudinal profile of the holding device, wherein said capsule is advantageously fixedly installed. This means that, by means of the installing in a capsule, the emitters are present as a more easily handleable constructional unit. By installing a capsule in the longitudinal profile of the holding device, it is possible for the holding device to be interrupted for receiving the capsule or for connecting to the capsule. This can take place at two end regions, in particular opposite end regions, of the capsule. Free ends of partial holding device can be fastened to said end regions, for example by means of rivets, split pins or screws. An aforementioned moveability or articulation of the entire holding device with the emitters thereon can thus also be achieved; this therefore does not have to be provided within the holding device itself. Within the context of the invention, such a construction with holding device divided up into a plurality of partial holders, wherein the partial holders are connected by means of the emitters or the capsules containing the emitters to form a single elongate structure, is always still understood to be an elongate holding device within the context of the invention.

It is possible to fixedly connect an aforementioned capsule to portions of the partial holders or of a continuous holding device by means of a threaded connection. This is of advantage especially if flexibility or articulation or moveability for the entire holding device is provided in individual regions of the partial holders themselves. Thus, external threads can protrude on the capsule and internal threads can be provided at a free end of a partial holding device. The entire holding device with the emitters thereon is then produced by screwing together.

For an aforementioned pin connection or split pin connection, also for a connection with rivets or screws, projections protruding on the capsules can be provided. Said projections can have a transverse bore. Corresponding projections can also be provided at free ends of a partial holding device, wherein the respective bores are brought into overlap and then a corresponding elongate connecting means is passed through them.

The conveying device is advantageously arranged in the storage device. In the case of the chains mentioned at the beginning, said conveying device can be a gearwheel or a chain wheel, as is known per se from the prior art for conveying chains. For shaft cores, wires or the like mentioned at the beginning, there can be two wheels or rollers lying with pressure in the direction towards each other against a shaft core or a wire.

It is possible, for example, for oil intermediate products or other liquid media, alternatively also at least tippable or pourable media, to be arranged in the container. Typically, there is sand, water, oil and gas one above another in oil production separators as containers. The arrangement also has a detector apparatus, advantageously in the container, for example in a further protective tube. As is known from the prior art, the detector apparatus is intended to run in parallel and/or offset with respect to the emitters at a small distance for precise measurement. For this purpose, reference is made to U.S. Pat. No. 6,633,625 B2 and US 2016/313264 A1 mentioned at the beginning. The detector apparatus can be arranged here within or else outside the container, depending on the constructional form thereof and the application.

These and further features emerge not only from the claims but also from the description and the drawings, where the individual features can be realized in each case by themselves or as a plurality in the form of sub-combinations in an embodiment of the invention and in other fields and can constitute advantageous and inherently protectable embodiments for which protection is claimed here. The subdivision of the application into individual sections and subheadings do not restrict the general validity of the statements made thereunder.

Other objects, advantages and novel features of the present invention will become apparent from the following detailed description of one or more preferred embodiments when considered in conjunction with the accompanying drawings.

### BRIEF DESCRIPTION OF THE DRAWINGS

Further advantages and aspects of the invention emerge from the claims and from the description below of preferred exemplary embodiments of the invention that are explained below with reference to the drawings, in which:

FIG. 1 shows a schematic illustration of a first refinement of an arrangement according to the invention with a storage device on a container,

FIG. 2 shows a modification of the arrangement from FIG. 1 with a storage device configured somewhat differently,

FIG. 3 shows an enlarged illustration of a holding device disassembled into partial holders, in the form of a shaft core with a capsule, with emitters therein, which can be screwed in,

FIG. 4 shows an alternative holding device in the form of a round link chain with a capsule, with emitters therein, screwed on, and

FIG. 5 shows a further alternative holding device as a round link chain with a capsule, with emitters therein, welded in laterally.

### DETAILED DESCRIPTION OF THE DRAWINGS

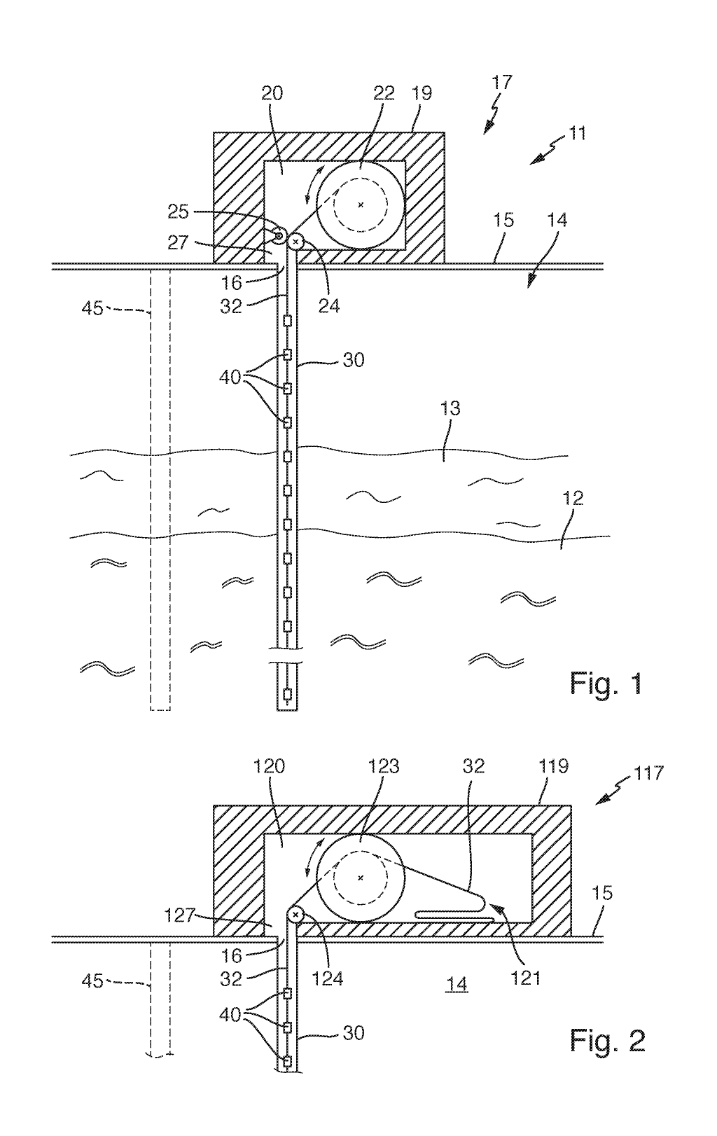

FIG. 1 illustrates an arrangement 11 according to the invention in a first refinement of the invention. The level of an aforementioned mixture of sand, water, oil and gas or the boundary layer between water 12 and oil 13 in a container 14, for example a relatively large tank, as is used in particular in oil drilling platforms or in other mixtures in refineries, chemical plants or the oil-processing industry, is intended to be measured or monitored here. For this purpose, a container cover 15 is provided with a container opening 16 on to which an apparatus according to the invention for measuring the level of the oil 13 or for measuring the boundary layer between water 12 and oil 13 is placed or is fastened thereabove. There can also be a gas above the oil 13.

The apparatus 17 essentially has a storage device 19 in the manner of a box or housing which is lined with lead for shielding against rays. The storage device 19 is therefore storage for the emitters together with holding device and also a radiation protection container. This is necessary for inspection of the container. The emitters are then namely retracted and the storage device 19 is completely closed from the inside at an access opening 27 so that people in the container 14 cannot be exposed to the radiation. The container advantageously has a connecting piece with a flange for attaching the storage device 19.

A large drum 22 with a drum core (illustrated by dashed lines) and a drive (not illustrated) is provided in an interior space 20 of the storage device 19. The drive can also have path detection here, as is explained in more detail below. Said path detection is of great significance in order, when the holding device is reintroduced into the protective tube, to reach the precise position or a reproducible position of the emitters when the holding device covers a known path. The emitters 40 together with the holding device 32 are advantageously either completely extended or completely removed.

A guide wheel 24 is provided on the right at the access opening 27 at the bottom of the storage device 19, said access opening lying above the container opening 16 or being aligned therewith. Said guide wheel can be configured as a wheel, grooved wheel, gearwheel or wide roller or the like. A press-on wheel 25 can be arranged opposite the guide wheel 24 but is only optionally present. If a holding device 32 (explained in more detail below) does not lie against the guide wheel 24 in a form-fitting manner or is engaged by the latter, said press-on wheel serves to press the holding device against the guide wheel 24 in such a manner that an undesirable slip does not arise. Good guidance of the holding device 32 is then ensured. Additionally or alternatively, an aforementioned path detection for the holding device 32 can also be provided on the guide wheel 24. In yet a further refinement of the invention, the guide wheel 24 can also be driven in addition to the drum 22 and, for example, additionally or very generally can primarily convey the holding device 32 or pull the latter upwards. Thus, at the drum 22, only a rotation takes place for the receiving or winding up of the holding device as described at the beginning.

A protective tube 30 is fitted, advantageously fastened or screwed or welded from below on to the container opening 16. Alternatively, the protective tube 30 can also be fastened to the lower region of the storage device 19, and therefore a tight connection is provided here in all situations. Furthermore, it is thus very generally possible for a dedicated constructional unit of storage device 19 and protective tube 30 to be formed.

A detector tube 45 (illustrated by dashed lines) runs parallel to the protective tube. Detectors corresponding to the emitters 40, as is known from the prior art mentioned at the beginning, are located in said detector tube. The detectors can advantageously be arranged here at the same vertical height as the emitters 40. As explained previously, the detector tube 45 or the detectors can be arranged outside the container 14, for example also in an arcuate or curved tube which follows the outer shape of the container 14.

In a similar manner as described previously for the protective tube 30, the detector tube 45 can likewise be fastened to the lower side of the storage device 19. A constructional unit with the two tubes 30 and 45 can thus be created, said constructional unit being arranged on a container 14 or a container cover 15 with two corresponding openings, and therefore the two tubes 30 and 45 reach downward. For a space-saving arrangement, the detector tube 45 could be arranged here on the right next to the protective tube 30, specifically approximately below the drum 22. In yet another, easily conceivable, alternative refinement of the invention, a further drum or the like as in the case of the storage device 19 could be provided for the detector tube 45 or the detectors arranged therein, as are likewise fastened to a flexible and length-invariable holding device, in a similar manner as the emitters 40. The detectors could thus also be pulled easily out of the container 14 or the detector tube 45 for maintenance, repair or the like and stored here at the same time in a practicable and space-saving manner, but preferably in another storage device to protect against radiation. They can likewise be introduced again precisely and positionally correctly into the container.

From the drum 22, the elongate holding device 32 runs downwards via the guide wheel 24 through the access opening 27 and the container opening 16 into the protective tube 30. The holding device 32 can reach here as far as shortly before the lower end of the protective tube 30, i.e. can make maximum use of the length thereof. The press-on wheel 25 lies against the holding device 32 from the left, for the previously described pressing of the holding device 32 against the guide wheel 24.

Emitters 40 (illustrated in simplified form) are arranged on the holding device 32. Said emitters can be arranged at an equal distance from one another, for example every 5 cm to 10 cm or even 20 cm to 100 cm. Different distances are also conceivable, but can restrict the universal useability of such a holding device.

According to the invention, the holding device 32 is intended to be length-invariant, i.e. is intended not to be able to be lengthened or extended due to its deadweight plus the weight of the emitters 40, which hangs downwards and pulls downwards in the protective tube 30. This applies to forces which can be anticipated during normal operation and can advantageously lie within a range mentioned at the beginning. Furthermore, the holding device 32 is advantageously of such flexibility that it can be wound up on the drum 22, specifically advantageously completely. The holding device 32 together with emitters 40 can thus be completely removed from the protective tube 30 or even the lowermost emitter 40 can readily be reached for maintenance, replacement or repair purposes.

The storage device 19, since radioactive emitters 40 are involved, can be appropriately insulated or lined. For this purpose, it can be composed of a material which readily shields against the radiation, and can in particular contain lead.

An alternative refinement of an arrangement 111 of a storage device 119 on the container 14 according to FIG. 1 with a container cover 15 and detector 45 is illustrated in FIG. 2. An elongate holding device 32 with emitters 40, as can basically also correspond to that of FIG. 1, can be used here. However, the holding device 32 here can be a holding device which, despite its flexibility, cannot be wound up very readily on to a drum or should not be wound up thereon. Instead of the drum 22 from FIG. 1 for winding up the holding device together with emitters thereon, the storage device 119 in the interior space 120 has a transport wheel 123. The latter can be driven and, together with a guide wheel 124 at an access opening 127 of the storage device 119 above a container opening 16, can move the elongate holding device 32 upwards or downwards out of the protective tube 30. If the holding device 132 is conveyed or moved upwards or out of the protective tube 30, it is simply conveyed by the transport wheel 123 into a depositing space 121 arranged on the right next to the latter, or deposited in said depositing space. Under some circumstances, such a depositing can take place in a more force- and material-protecting manner than winding up according to FIG. 1, in particular because the holding device 32 can be deposited with greater radii or loops. A primary drive can take place here via the transport wheel 123. Also, similarly as explained above, path detection of the gathered or discharged holding device 30 can take place at the transport wheel 123 or at the guide wheel 124.

A further advantage of a storage device 119 according to FIG. 2 is that the holding device 32 and especially the emitters 40 are to some extent readily accessible in the depositing space 121, for example for aforementioned maintenance or repair purposes. The depositing space 121 can be made accessible from the outside through an access flap (not illustrated here) or the like, and work can be carried out at a plurality of locations on the holding device 32 or on emitters 40. This is not possible if all is wound up on to a drum 22 according to FIG. 1. However, maintenance in situ is typically not provided because of the risk of radiation.

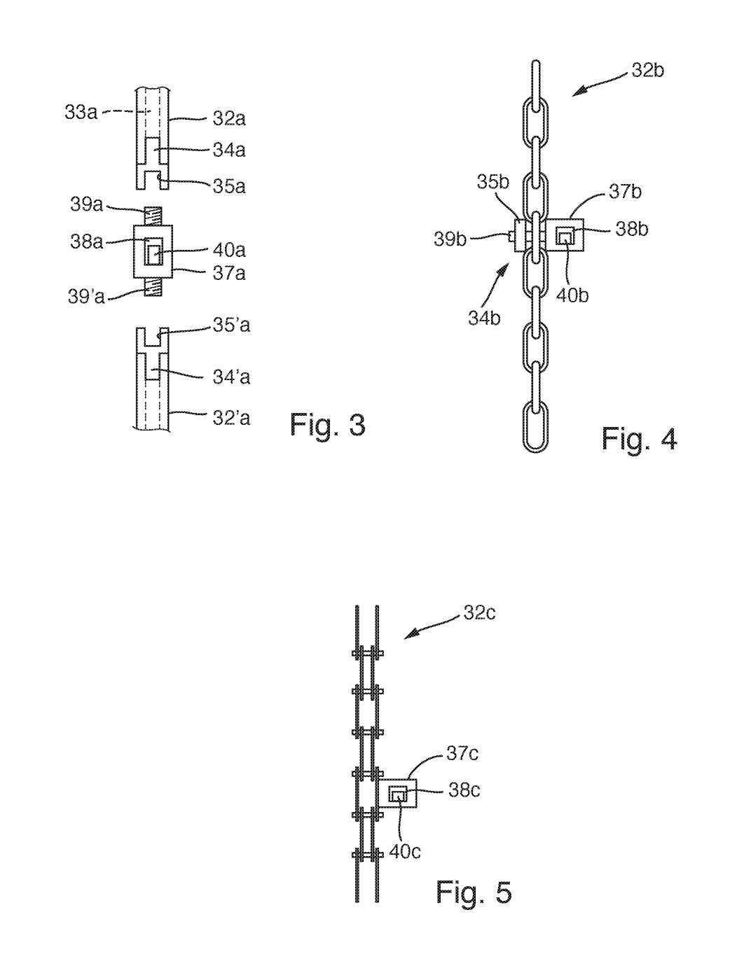

Various refinements of an elongate holding device 32 and possibilities for fastening an emitter 40 thereon are illustrated in FIGS. 3 to 5. In FIG. 3, a holding device 32a is configured as a partial holding device in the form of a shaft core mentioned at the beginning. Said shaft core 32a is manufactured from metal and advantageously has two layers, lying one inside the other, of coiled metal wires. In particular, said layers lie very closely together. Such a holding device consisting of shaft cores 32a is stable with respect to a shearing force and can thus be introduced even into protective tubes which have a complicated and, under some circumstances, multiply bent profile or a somewhat dented or the like. At the same time, the flexibility of such holding device is sufficiently good in order to be deposited in bays or to be wound up on to a drum. Finally, with sufficiently stable manufacturing, the length invariance is also sufficient for the purposes described here. Even the previously mentioned forces of 10 N to 100 N or even 500 N cannot extend stably produced shaft cores 32a.

In a simple refinement, an emitter 40 can either be fastened to the outer side of a continuous shaft core 32a, for example can be fastened with a clip or a clamp. Alternatively, an insert component 34a can be provided which is pressed with an upwardly extending shoulder into a core space 33a. Under some circumstances, a thread matching the inner coiled profile can be provided here, and therefore the insert component 34a is screwed, as it were, into the shaft core 32a or the core space 33a thereof.

At the opposite end, the insert component 34a has an internal thread 35a. A capsule 37a with an upwardly pointing, mating external thread 39a can be screwed therein.

A further external thread 39a′ is provided at the bottom of the capsule 37a and can be screwed into an internal thread 35a′ of a lower insert component 34a′. The insert component 34a′ can be fastened in principle like the upper insert component 34a to the shaft core 32a or screwed with a mating thread into a core space.

It can readily be seen from FIG. 3 that, with this refinement, an elongate holding device 32a consisting of portions or partial holders of shaft cores which are held together by a capsule 37a is produced. A capsule space 38a is provided in the capsule 37a. An emitter 40 is arranged in said capsule space.

Even if here, in FIG. 3, the actual shaft core 32a is not continuous, but rather is interrupted time and again by the screwed-in capsules 37a and is divided into the partial holders, nevertheless an elongate and overall continuous holding device is referred to within the context of the invention. Said holding device also has the length invariance according to the invention, as has been explained previously.

In an easily conceivable alternative refinement, instead of the flexible shaft cores 32a, use could also be made of solid metal rods as partial holders. A connection to the capsules 37, which are inserted in between and have emitters 40 therein, could then be configured, as has been explained at the beginning, in an articulated manner such that a type of link chain is present. This would then likewise again be a length-invariant and moveable or flexible holding device according to the invention.

FIG. 4 illustrates an alternative refinement of the holding device as a round link chain 32b. The round link chain 32b is continuous and not interrupted in its length with individual round links or elongate chain links, i.e. a continuous holding device. An emitter 40b is arranged in a capsule 37b or in the capsule space 38b thereof. Protruding to the left from the capsule 37b is an elongate thread which is plugged through a link opening of a chain link. A nut 35b or the like can be screwed on to an external thread 39a of the component 34b formed in this manner. The capsule 37b together with emitter 40b is thus fastened fixedly to the round link chain 32b. Although the movability of the round link chain 32b is then restricted in said region, it is nevertheless sufficiently moveable and flexible overall in order to be wound up on to a drum according to FIG. 1 or to be deposited in a plurality of bays according to FIG. 2.

Alternatively, the round link chain 32b could also be separated into a plurality of individual chain portions similarly to FIG. 3 as partial holders. The latter can then be connected to one another by means of inserts or insert components 34b together with capsules and emitters therein and can thus produce a continuous elongate holding device together with emitters.

In yet another refinement of the invention according to FIG. 5, a roller chain 32c is provided. Similarly to the round link chain 32b from FIG. 4, the roller chain 32c is also continuous and without interruption. A capsule 37c with capsule space 38c and emitters 40c therein is fastened laterally to a wide chain link, for example is fixedly welded or fixedly screwed thereto. The interior space in said chain link can thus be maintained, as a result of which the roller chain 32c, as can readily be seen from the illustration of FIG. 5, not only maintains its complete articulation, but can also be very readily conveyed in a slip-free manner with, for example, a gearwheel as guide wheel 24 according to FIG. 1 or guide wheel 124 according to FIG. 2.

Even in the case of the roller chain 32c of FIG. 5, a division into individual portions or partial holders can take place with insert components to be inserted or capsules together with emitters therein, in a similar manner as is illustrated in FIG. 3.

The advantages mentioned at the beginning of very precise and simple positioning of the individual emitters in a measurement position according to FIG. 1 in combination with a storage device together with shielding to the outside, said storage device not requiring much space, can thus be achieved. This increases measurement accuracy, saves production costs and assembly costs and permits simpler handling of the emitters and shielding during the assembly and inspection or maintenance. Since, in addition, there is also only one single holding device for emitters, nothing more can be involved in retracting and extending the emitters. Finally, the diameter of the protective tube can also be reduced.

A shaft core as a holding device also has the general advantage that said shaft core always adopts a maximum bending radius or strives for a rectilinear state and therefore achieves very high positioning accuracy in a protective tube bent once or more than once. It is thus ensured that the emitters are placed again after removal into the same position. This avoids re-calibration of the measurement. The precise emitter positioning or reproducibility is simply of great importance.

In yet another refinement of the invention, a wire cable can be used as the holding device. This can basically also be divided, in a similar manner as illustrated in FIG. 3, into individual portions which are then connected to one another, for example by means of capsules or the like which contain the emitters. However, an arrangement of the emitters in capsules is advantageously undertaken from the outside in the case of a wire cable, for example with U-shaped screw clamps or the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for measuring a level and/or for measuring a density profile of a medium in a container, comprising:
a plurality of radioactive emitters being mutually movable in order to be arranged at a different height level in each case in said container;
a protective tube reaching into said container with an extent at least partially in a vertical direction;
an elongate holding device for said emitters, said elongate holding device being introducible into said protective tube, wherein said holding device is configured to be length-invariant, and wherein said emitters are fastened to said holding device,
a storage device for said holding device together with said emitters,
a connection from said storage device to said protective tube,
a conveying device for said holding device for conveying said holding device into said protective tube and out of said protective tube, wherein
said storage device for storing said holding device with said emitters thereon is configured in a non-elongate form.

2. The apparatus according to claim 1, wherein said storage device for storing said holding device with said emitters thereon is configured in a roundly consolidated form.

3. The apparatus according to claim 2, wherein said storage device has a drum for winding up said holding device with said emitters thereon for storage.

4. The apparatus according to claim 2, wherein said storage device is configured for depositing said holding device with said emitters thereon on a floor of said storage device in bays.

5. The apparatus according to claim 1, wherein said storage device is arranged directly at an outlet of said protective tube from said container and directly above said protective tube.

6. The apparatus according to claim 1, wherein said holding device is at least partially composed of metal.

7. The apparatus according to claim 1, wherein said holding device is movable in a flexurally flexible or articulated manner at least in one plane.

8. The apparatus according to claim 7, wherein said holding device is movable in a flexurally flexible or articulated manner in all directions.

9. The apparatus according to claim 1, wherein said holding device is stable with respect to a shearing force or is shearing-resistant, respectively.

10. The apparatus according to claim 1, wherein said holding device is a shaft core.

11. The apparatus according to claim 10, wherein said holding device is a shaft core with at least two layers of wound wires.

12. The apparatus according to claim 1, wherein said holding device is a chain with individual chain segments.

13. The apparatus according to claim 12, wherein said chain has chain links interconnected in an interlaced manner.

14. The apparatus according to claim 12, wherein said chain is a roller chain.

15. The apparatus according to claim 1, wherein said emitters are encapsulated or shielded.

16. The apparatus according to claim 15, wherein in each case one said emitter is arranged in one said capsule, and said capsule is installed in a longitudinal profile of said holding device.

17. The apparatus according to claim 15, wherein said holding device is interrupted and has a plurality of partial holders for receiving said capsule or for connecting to said capsule at two end regions of said capsule.

18. The apparatus according to claim 17, wherein free ends of said partial holders connect to said end regions of said capsule.

19. The apparatus according to claim 15, wherein said capsule is fixedly connected to portions of said holding device or of partial holders with a threaded connection.

20. The apparatus according to claim 19, wherein said threaded connection has external threads protruding from said capsule, and wherein internal threads are provided at free ends of said partial holders.

21. The apparatus according to claim 18, wherein said capsule is connected to portions of said free ends of said partial holders by a pin connection or by a split pin connection.

22. The apparatus according to claim 21, wherein projections are provided which are protruding from said capsule, and corresponding depressions are provided at said free ends of said partial holders.

23. An arrangement of the apparatus according to claim 1 on a container, wherein said arrangement has a detector for detecting a position and/or a height of said emitters.

24. The arrangement according to claim 23, wherein said container is a container for products of oil production separators.

25. The arrangement according to claim 23, wherein said protective tube projects from above into said container, wherein said storage device is arranged directly above an outlet of said protective tube from said container.
